(19) United States
(12) Patent Application Publication
(10) Pub. No.: US 2025/0226421 A1
(43) Pub. Date: Jul. 10, 2025

(54) ELECTROCHEMICAL CELLS AND CURRENT COLLECTORS FOR USE WITH SAME

(71) Applicant: Medtronic, Inc., Minneapolis, MN (US)

(72) Inventor: Joseph J. Viavattine, Vadnais Heights, MN (US)

(21) Appl. No.: 18/978,779

(22) Filed: Dec. 12, 2024

Related U.S. Application Data
(60) Provisional application No. 63/617,582, filed on Jan. 4, 2024.

(51) Int. Cl. H01M 4/72

(52) U.S. Cl. CPC H01M 4/72

(57) ABSTRACT

Electrochemical cells and current collectors for use therein having a web width value or a web cross-sectional area that decreases along a longitudinal axis of the current collectors are provided herein. More specifically, elongate current collectors are provided having a plurality of current collector segments, each segment having a web of electrically conductive material defining a hole through the current collector and having a web width or a web cross-sectional area. The width or the cross-sectional area of each segment decreases as the plurality of segments extends along a longitudinal axis of the current collector.

### RELATED APPLICATIONS

This application claims the benefit of U.S. Provisional Application Ser. No. 63/617,582, filed Jan. 4, 2024, the entire contents of each of which are incorporated herein by reference.

### TECHNICAL FIELD

The present disclosure generally relates to the field of lithium batteries or cells and, more specifically, to current collectors for use in lithium batteries or cells.

### BACKGROUND

Electrochemical cells, such as lithium batteries, include one or more positive electrodes, one or more negative electrodes, and a liquid electrolyte provided within a case or housing. Separators made from a porous polymer or other suitable material may also be provided between the positive and negative electrodes to prevent direct contact between adjacent electrodes, and electrolytes penetrate through pores in the porous separator.

Batteries typically further include current collectors to carry electrical current to and from each of the electrodes, for example, so that the battery may be electrically coupled with an electronic device, such as an implantable medical device. Generally, a battery includes a current collector for each electrode, and each current collector is electrically coupled to its respective electrode.

In general, desirable characteristics for electrochemical cells include high energy density, high power density, and longevity. Each of these characteristics may be particularly desirable for use in implantable medical devices, such as pacemakers, insulin pumps, cardioverter-defibrillators, drug delivery pumps, and neurostimulators, which could improve the lives, comfort, and quality of care for patients living with or receiving implantable medical devices.

### SUMMARY

As described herein, electrochemical cells include current collectors to carry electrical current to and from electrodes, for example, so that the cell may be electrically coupled with an electronic device, such as an implantable medical device. Each current collector may be electrically coupled to its respective electrode, such as directly or via an electrically conductive material. Mechanical durability is an important characteristic of a current collector, for example, to resist fracture under stress during manufacturing or operation.

The process of forming an electrochemical cell may put stress on the current collector. In one example, the current collector may be stressed (e.g., stretched or compressed) during cathode pressing, which may be described as a process of pressing cathode active material (e.g., as part of a cathode composite) in a mold or dye to form a solid cathode. The current collector may be disposed in the cathode active material during cathode pressing to form the cathode around the current collector, which may cause stress and distortion of the current collector. Depending on the nature of the dose and dispense process in cathode pressing, the movement of cathode composite during compression can lead to more movement of the mix vertically (or along a longitudinal axis of the current collector), which may result in uneven stretching of the current collector. In other words, one portion of the current collector may be subject to greater stress than other portions.

Surface area, cohesion, and volume are other examples of important characteristics in current collectors. A relatively high surface area may be desirable to increase available interfacial area between the current collector and the electrode to improve flow of electrons across the interface, and cohesion may be desirable to improve mechanical stability of the interfaces between the current collector and the electrode. Additionally, a relatively high cross-section of electrically conductive material (e.g., thickness) of a current collector may be desirable to improve current carrying ability. On the other hand, a relatively low overall volume of the current collector may be desirable to reduce the inactive material in an electrode assembly (i.e., volume of materials other than electrode active material).

As described herein, current collectors may be provided with improved mechanical durability and with reduced, or no, cost to other desirable characteristics, such as high surface area, low volume, and high cohesion.

Embodiments disclosed herein may include an electrochemical cell having a first electrode including an electrode composite, an elongate current collector, a second electrode, a separator disposed between the first electrode and the second electrode, and an electrolyte. The current collector may include electrically conductive material and define a longitudinal axis and may extend from a surface of the first electrode and into the first electrode along the longitudinal axis. The current collector may have a first major surface and an opposing second major surface and a plurality of current collector segments extending along the longitudinal axis. Each segment may have: a web of the electrically conductive material, the web (i) defining a hole extending through the current collector from the first major surface to the second major surface and having a respective hole width value measured along a respective segment axis extending across the hole and perpendicular to the longitudinal axis; (ii) having a respective web width value measured along the respective segment axis; and (iii) connecting the segment to at least one adjacent current collector segment, wherein each segment defines a respective segment width value measured along the respective segment axis. The respective web width value of each segment decreases as the plurality of segments extends along the longitudinal axis from the surface of the electrode into the electrode.

The electrode composite may be disposed within each hole of the plurality of segments. At least one segment of the plurality of segments may be at least partially discrete from the respective at least one adjacent current collector segment. At least one segment of the plurality of segments may be continuous with the respective at least one adjacent current collector segment. The current collector may be monolithic. The respective segment axis of each segment may be defined across a maximum hole width of the respective hole. The respective segment axis of each segment may be defined across a minimum web width of the respective web. The respective hole width value of each segment may increase as the plurality of segments extends along the longitudinal axis from the surface of the electrode into the electrode, the respective segment width value of each segment may decrease as the plurality of segments extends along the longitudinal axis from the surface of the electrode into the electrode, or both. The respective hole width value of each segment may be equal. The respective segment width value of each segment may be equal. The current collector further may define a notch between a segment of the plurality of segments and the respective at least one adjacent segment.

Further embodiments disclosed herein may include a current collector having an elongate body defining a longitudinal axis and extending from a first end region to a second end region along the longitudinal axis. The elongate body may include electrically conductive material and may have a first major surface and an opposing second major surface, a plurality of current collector segments extending along the longitudinal axis. Each segment may have a web of the electrically conductive material, the web (i) defining a hole extending through the elongate body from the first major surface to the second major surface and having a respective hole width value measured along a respective segment axis extending across the hole and perpendicular to the longitudinal axis; (ii) having respective a web width value measured along the respective segment axis; and (iii) connecting the current collector segment to at least one adjacent current collector segment, wherein each segment defines a respective segment width value measured along the respective segment axis. The respective web width value of each segment decreases as the plurality of segments extends along the longitudinal axis from the first end region of the elongate body to the second end region of the elongate body.

At least one segment of the plurality of segments may be at least partially discrete from the respective at least one adjacent current collector segment. At least one segment of the plurality of segments may be continuous with the respective at least one adjacent current collector segment. The elongate body may be monolithic. The respective segment axis of each segment may be defined across a maximum hole width of the respective hole. The respective segment axis of each segment may be defined across a minimum web width of the respective web. The respective hole width value of each segment may increase as the plurality of segments extends along the longitudinal axis from the first end region of the elongate body to the second end region of the elongate body, the respective segment width value of each segment may decrease as the plurality of segments extends along the longitudinal axis from the first end region of the elongate body to the second end region of the elongate body, or both. The respective hole width value of each segment may be equal, or the respective segment width value of each segment may be equal. The elongate body may further define a notch between a segment of the plurality of segments and the respective at least one adjacent segment.

Still further embodiments disclosed herein may include a current collector having an elongate body defining a longitudinal axis and extending from a first end region to a second end region along the longitudinal axis. The current collector's elongate body may include electrically conductive material and may have a first major surface and an opposing second major surface and a plurality of current collector segments extending along the longitudinal axis. Each segment may have a web of the electrically conductive material, the web (i) defining a hole extending through the elongate body from the first major surface to the second major surface; (ii) having a respective web cross-sectional area measured on a respective cross-sectional plane extending across a respective local minimum cross-sectional area of the web and perpendicular to the longitudinal axis; and (iii) connecting the segment to at least one adjacent current collector segment. The respective web cross-sectional area of each segment decreases as the plurality of segments extends along the longitudinal axis from the first end region of the elongate body to the second end region of the elongate body.

The web of each segment may further have a respective web thickness value measured along a respective axis extending through the elongate body from the first major surface to the second major surface and optionally lying on the respective cross-sectional plane. The respective web thickness value of each segment may decrease as the plurality of segments extends along the longitudinal axis from the first end region of the elongate body to the second end region of the elongate body. Each segment may further have a respective segment width value measured along a respective axis parallel to the first major surface or the second major surface and optionally lying on the respective cross-sectional plane. The respective segment width value of each segment may decrease as the plurality of segments extends along the longitudinal axis from the first end region of the elongate body to the second end region of the elongate body.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1A is a schematic cross-sectional side view of an illustrative electrochemical cell according to one or more embodiments of the present disclosure.

FIG. 1B is a schematic cross-sectional side view of an illustrative electrode assembly of the electrochemical cell of FIG. 1A.

FIGS. 2A-2B are cross-sectional side views of an illustrative current collector for use in the electrochemical cell of FIG. 1A.

FIGS. 3A-3B are cross-sectional side views of other illustrative current collectors.

FIGS. 4A-4G are cross-sectional side views of various embodiments of an illustrative current collector.

FIG. 5A is a perspective view of an illustrative current collector with a tapered thickness.

FIG. 5B is a cross-sectional perspective view across the third cross-sectional plane of the illustrative current collector of FIG. 5A.

The figures are rendered primarily for clarity and, as a result, are not necessarily drawn to scale. Moreover, various structure/components may be shown diagrammatically or removed from some of or all the views to better illustrate aspects of the depicted embodiments, or where inclusion of such structure/components is not necessary to an understanding of the various illustrative embodiments described herein. The lack of illustration/description of such structures/components in a particular figure is, however, not to be interpreted as limiting the scope of the various embodiments in any way.

### DETAILED DESCRIPTION

All scientific and technical terms used herein have meanings commonly used in the art, unless otherwise specified. The definitions provided herein are to facilitate understanding of certain terms used frequently herein and are not meant to limit the scope of the present disclosure.

Unless otherwise indicated, the terms “polymer,” “polymerized monomers,” and “polymeric material” include, but are not limited to, organic homopolymers, copolymers, such as, for example, block, graft, random and alternating copolymers, terpolymers, etc., and blends and modifications thereof. Furthermore, unless otherwise specifically limited, the term “polymer” shall include all possible geometrical configurations of the material. These configurations include, but are not limited to, isotactic, syndiotactic, and atactic symmetries.

The term “substantially” modifies the term that follows by at least about 90%, at least about 95%, or at least about 98%. “Substantially” includes “significantly,” which refers to statistical significance.

The term “not substantially” modifies the term that follows by not more than 25%, not more than 10%, not more than 5%, or not more than 2%.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise. The terms “and/or” and “any combination thereof” and their grammatical equivalents, as used herein, can be used interchangeably. These terms can convey that any combination is specifically contemplated. Solely for illustrative purposes, the following phrases “A, B, and/or C” or “A, B, C, or any combination thereof” can mean “A individually; B individually; C individually; A and B; B and C; A and C; and A, B, and C.” The term “or” can be used conjunctively or disjunctively unless the context specifically refers to a disjunctive use.

The recitations of numerical ranges by endpoints include all numbers subsumed within that range (e.g., 1 to 5 includes 1, 1.5, 2, 2.75, 3, 3.80, 4, 5, etc. and 10 or less includes 10, 9.4, 7.6, 5, 4.3, 2.9, 1.62, 0.3, etc.). Where a range of values is “up to,” “at most,” or “at least” a particular value, that value is included within the range.

As used herein, “have,” “having,” “include,” “including,” “comprise,” “comprising,” or the like are used in their open-ended sense, and generally mean “including, but not limited to.” It will be understood that “consisting essentially of,” “consisting of,” and the like are subsumed in “comprising” and the like. As used herein, “consisting essentially of,” as it relates to a composition, product, method, or the like, means that the components of the composition, product, method, or the like are limited to the enumerated components and any other components that do not materially affect the basic and novel characteristic(s) of the composition, product, method, or the like.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. It is contemplated that any embodiment discussed in this specification can be implemented with respect to any method or composition of the present disclosure, and vice versa. Furthermore, compositions of the present disclosure can be used to achieve methods of the present disclosure. Such inclusive or open-ended words encompass more restrictive or closed terms or phrases, such as “consisting” or “consisting essentially.”

Reference in the specification to “some embodiments,” “an embodiment,” “one embodiment,” “embodiments,” “one or more embodiments,” “at least one embodiment,” or “other embodiments” means that a particular feature, structure, or characteristic described in connection with the embodiments is included in at least some embodiments, but not necessarily all embodiments, of the present disclosures.

Any direction referred to herein, such as “top,” “bottom,” “left,” “right,” “upper,” “lower,” and other directions and orientations are described herein for clarity in reference to the figures and are not to be limiting of an actual device or system or use of the device or system. Devices or systems as described herein may be used in a number of directions and orientations.

In several places throughout the application, guidance is provided through examples, which examples, including the particular aspects thereof, can be used in various combinations and be the subject of claims. In each instance, the recited list serves only as a representative group and should not be interpreted as an exclusive list. It is to be understood that the particular examples, materials, amounts, and procedures are to be interpreted broadly in accordance with the scope and spirit of the present disclosure.

Reference will now be made in greater detail to various embodiments of the subject matter of the present disclosure, one or more embodiments of which are illustrated in the accompanying drawings. Like numbers used in the figures refer to like components and steps. However, it will be understood that the use of a number to refer to a component in a given figure is not intended to limit the component in another figure labeled with the same number. In addition, the use of different numbers to refer to components in different figures is not intended to indicate that the different numbered components cannot be the same as or similar to other numbered components.

As described herein, current collectors may be provided with improved and/or optimized mechanical durability and with reduced, or no, cost to other desirable characteristics, such as high surface area, low volume, and high cohesion. In particular, current collectors described herein may have improved mechanical durability in portions subject to, or expected to be subject to, greater stress (such as compression or stretching during cathode pressing). For example, current collectors described herein may include an overall taper of amount (such as thickness, cross-sectional area, mass, etc.) of material between portions subject to greater stress and portions subject to lesser or negligible stress. As a more specific example, a current collector configured to be subjected to cathode pressing may be provided having material tapered from a first thickness, width, or cross-sectional surface area at one end to a second thickness width, or cross-sectional surface area that is less than the first thickness, width, or cross-sectional area at the other end.

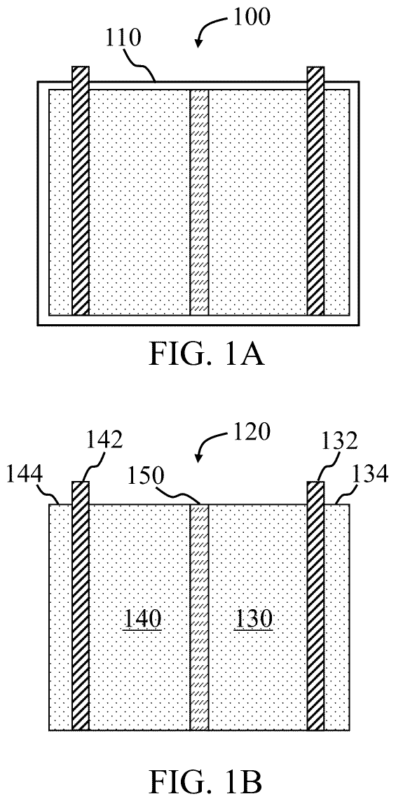

A schematic cross-sectional side view of an illustrative electrochemical cell 100 according to one or more embodiments of the present disclosure is shown in FIG. 1A. It will be understood in light of the present disclosure that any suitable electrochemical cell configuration may be used, including prismatic configurations, button/coin configurations, and pouch configurations, as a few examples, and the disclosure is not limited in this regard. In one or more embodiments, the electrochemical cell 100 may be a lithium cell, or battery.

The electrochemical cell 100 may include a housing 110. The housing 110 serves to contain the contents of the cell 100. Although not shown, in some embodiments, the housing 110 may be a conductive housing (that is, a housing at a non-neutral polarity). In such examples, the housing 110 may be electrically conductive and may serve as an electrode or a current collector, or part of an electrode or current collector, to complete the circuit of the battery. In some embodiments, the interior surface (the surface facing or in contact with the electrode assembly), or a portion of the interior surface, of the housing may be coated with an insulative material.

A schematic cross-sectional side view of an illustrative electrode assembly 120 of the electrochemical cell 100 of FIG. 1A is shown in FIG. 1B. The electrode assembly 120 includes a first electrode 130, a second electrode 140, a separator 150 disposed between the first electrode 130 and the second electrode 140, and an electrolyte (not expressly shown).

The first electrode 130 may be, or include, a first electrode composite. The first electrode composite may include a first electrode active material (e.g., a cathode active material or an anode active material). The first electrode composite may further include other suitable materials, such as one or more binders, one or more conductive additives, etc. The first electrode active material may be described as a material that participates in the electrochemical reaction when charging and/or discharging the electrochemical cell 100. The first electrode 130 may have a polarity. For example, the first electrode 130 may be a cathode or the first electrode 130 may be an anode.

The second electrode 140 may be, or include, a second electrode composite. The second electrode composite may include a second electrode active material (e.g., a cathode active material or an anode active material). The second electrode active material may be described as a material that participates in the electrochemical reaction when charging and/or discharging the electrochemical cell 100. The second electrode 140 may have a polarity, which may be the opposite polarity of the first electrode 130. For example, the second electrode 140 may be a cathode or the second electrode 140 may be an anode.

The electrode assembly 120 further includes a first current collector 132 electrically coupled to the first electrode 130 and a second current collector 142 electrically coupled to the second electrode 140. The current collectors may be electrically coupled to the respective electrode active materials, for example, directly or indirectly through a conductive material, and may be configured to carry electrical current to and/or from the electrodes 130, 140. The first current collector 132 may extend from a first electrode surface 134 and into the first electrode 130. Similarly, the second current collector 142 may extend from a second electrode surface 144 and into the second electrode 140.

It should be noted that, as used in this specification and the appended claims, reference to numbers of electrodes is merely for purposes of distinguishing between electrodes and does not necessarily limit the number of electrodes.

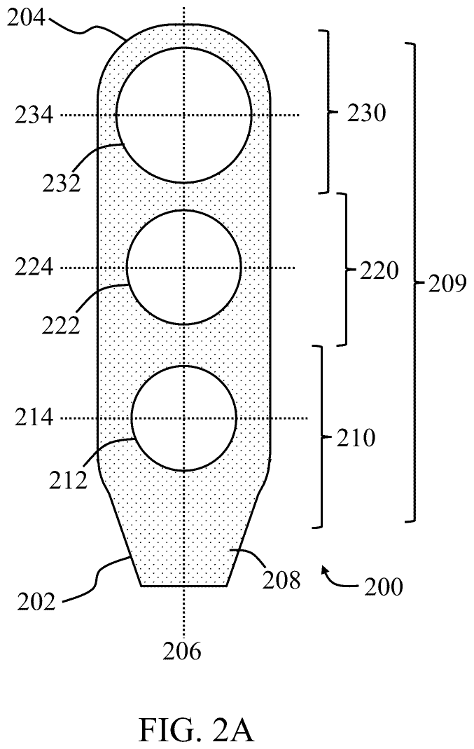

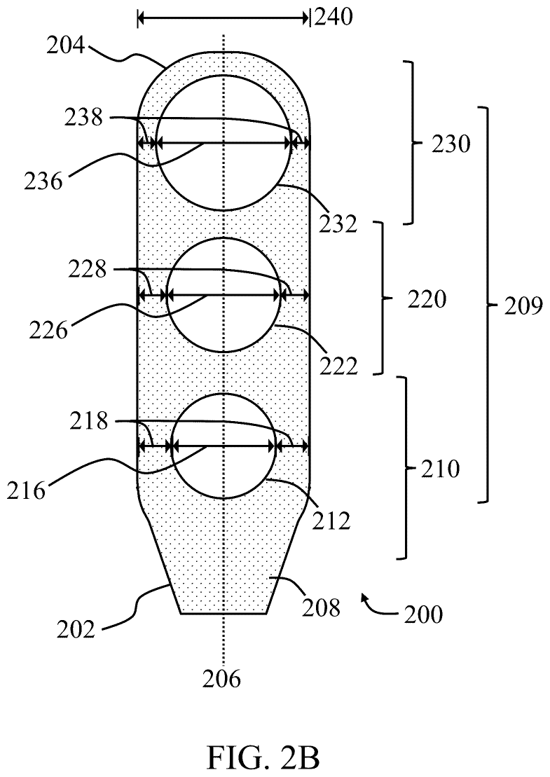

A cross-sectional view of an illustrative current collector 200 for use in the electrochemical cell 100 of FIG. 1A is shown in FIGS. 2A-2B. The current collectors described herein, such as the current collector 200, may be for use in electrochemical cells. For example, the current collectors described herein may be used in the electrochemical cell 100 as the first current collector 132 and/or the second current collector 142. The current collector 200 may be an elongate current collector, or have an elongate body, with a first end region 202 (e.g., a first end) and a second end region 204 (e.g., a second end). The current collector 200 may define a longitudinal axis 206 extending from the first end region 202 to the second end region 204. In one or more embodiments, the longitudinal axis 206 may extend from a surface of a first electrode (e.g., the first electrode surface 134 of the first electrode 130) and into the first electrode, or a first electrode composite (e.g., the first electrode composite of the first electrode 130), along the longitudinal axis 206. For example, the current collector 200 may be at least partially surrounded by, or embedded within, the first electrode composite.

In at least one embodiment, the current collector 200 is, or includes, an electrically conductive material, or a combination of electrically conductive materials. The current collector 200 may have a first major surface 208 and an opposing second major surface (not visible in FIGS. 2A-2B).

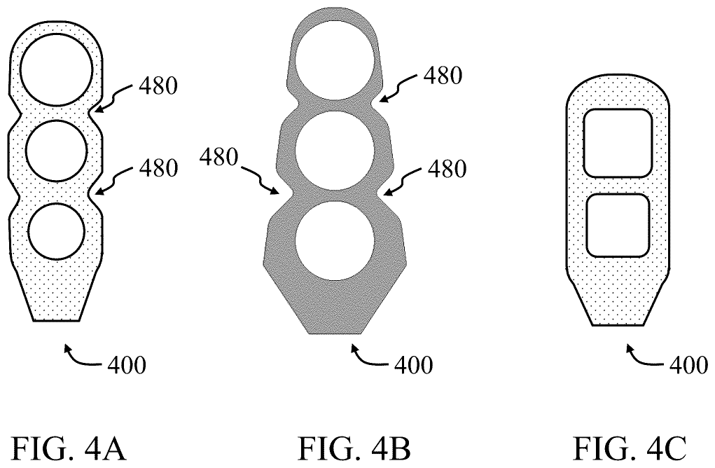

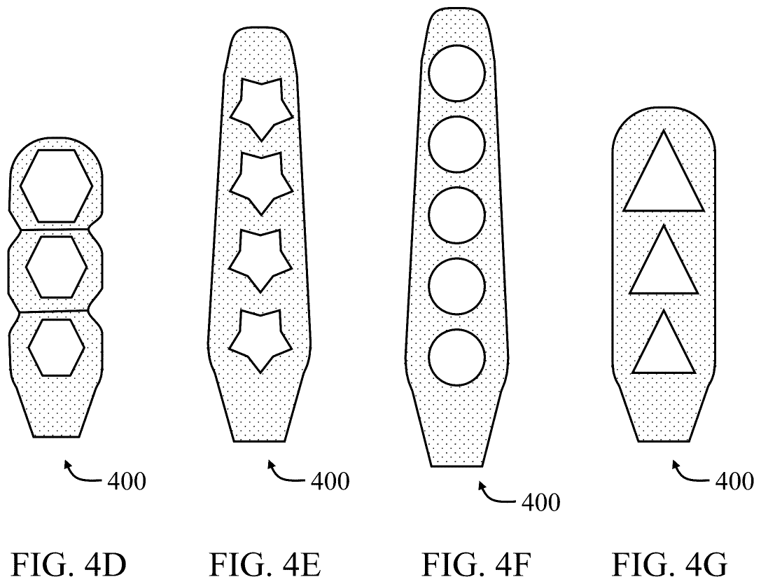

In some embodiments, the current collector 200 may have, or define, a plurality of segments 209, including, for example, a first segment 210, a second segment 220, and a third segment 230, as shown in FIGS. 2A-2B. At least one segment of the plurality of segments 209 may be continuous with at least one adjacent current collector segment. For example, the first segment 210 may be continuous with the second segment 220, the second segment 220 may be continuous with the first segment 210 and/or the third segment 230, and the third segment 230 may be continuous with the second segment 220. In other words, there may not be a discrete boundary, interface, or seam between each segment. In some embodiments, the current collector may be monolithic. A monolithic current collector may be described as having a continuous structure and/or surface without discrete boundaries, interfaces, or seams. While each segment of the plurality of segments 209 shown in FIGS. 2A-2B is shown as continuous with the other segments, at least one segment of the plurality of segments 209 may additionally or alternatively be at least partially discrete from at least one adjacent current collector segment (see, for example, FIG. 4D).

Each segment may have a web of the electrically conductive material defining a hole extending through the current collector 200 from the first major surface 208 to the second major surface. For example, the first segment 210 may define a first hole 212, the second segment 220 may define a second hole 222, and the third segment 230 may define a third hole 232. The web of each segment may connect (e.g., electrically connect and/or mechanically connect) the current collector segment to at least one adjacent current collector segment. For example, the web of the first segment 210 may connect the first segment 210 to the second segment 220, the web of the second segment 220 may connect the second segment 220 to the first segment 210 and/or the third segment 230, and the web of the third segment 230 may connect the third segment 230 to the second segment 220. In some embodiments, the electrode composite may be disposed within one or more holes of the plurality of segments 209. Electrode composite disposed within the holes of the current collector 200 may be desirable to provide cohesion of the electrode composite around and through the current collector 200, and to provide interfacial area between the current collector 200 and the electrode.

In one or more embodiments, each segment of the plurality of segments 209 may have, or define, a respective segment axis. Each segment axis may extend across the respective hole, and may optionally be substantially perpendicular (e.g., perpendicular or nearly perpendicular) to the longitudinal axis 206. For example, and as shown in FIG. 2A, the first segment 210 may have, or define, a first segment axis 214 across the first hole 212 and perpendicular to the longitudinal axis 206; the second segment 220 may have, or define, a second segment axis 224 across the second hole 222 and perpendicular to the longitudinal axis 206; and the third segment 230 may have, or define, a third segment axis 234 across the third hole 232 and perpendicular to the longitudinal axis 206. As shown in FIG. 2A, the respective segment axis of each segment may be defined across a maximum hole width of the respective hole. Additionally or alternatively, and as also shown in FIG. 2A, the respective segment axis may be defined across a minimum web width of the respective segment.

In at least one embodiment, each segment may define a respective segment width value. The segment width value may be described as a dimension of the segment measured across the segment (e.g., across a maximum or across the longitudinal center of the segment) along an axis substantially perpendicular (e.g., perpendicular or nearly perpendicular) to the longitudinal axis 206. The segment width value may optionally be measured along an axis substantially parallel (e.g., parallel or nearly parallel) to the first major surface and/or the second major surface. Each segment width value may be measured along the respective segment axis, for example. In one example, and as shown in FIG. 2B, the respective segment width value of each segment may be equal or substantially equal. In other words, each segment width value may be represented by a current collector width value 240.

In some embodiments, each hole of the plurality of segments 209 may have, or define, a hole width value, which may be described as a dimension, such as a maximum dimension, of the respective hole measured across the respective segment and substantially perpendicular (e.g., perpendicular or nearly perpendicular) to the longitudinal axis 206. The hole width value of each segment may be measured across the respective segment axis, for example. As shown in FIG. 2B, the first hole 212 may have, or define, a first hole width value 216 measured across the first segment axis 214; the second hole 222 may have, or define, a second hole width value 226 measured across the second segment axis 224; and the third hole 232 may have, or define, a third hole width value 236 measured across the third segment axis 234. In at least one embodiment, the respective hole width value of each segment may increase as the plurality of segments 209 extends along the longitudinal axis 206 from the first end region 202 to the second end region 204 (e.g., from the surface of the electrode into the electrode composite). For example, as shown in FIG. 2B, the first hole width value 216 may be less than the second hole width value 226, which may be less than the third hole width value 236. Likewise, the third hole width value 236 may be greater than the second hole width value 226, which may be greater than the first hole width value 216.

In one or more embodiments, each web of the plurality of segments 209 may have, or define, a respective web width value, which may be defined as a dimension, such as a minimum dimension, of the conductive material of the web measured across the respective segment and substantially perpendicular (e.g., perpendicular or nearly perpendicular) to the longitudinal axis 206. In other words, each web width value may be defined as the respective segment width value, minus the respective hole width value. The web width value of each segment may be measured across the respective segment axis. For example, as shown in FIG. 2B, the first segment 210 may have, or define, a first web width value 218 measured across the first segment axis 214; the second segment 220 may have, or define, a second web width value 228 measured across the second segment axis 224; and the third segment 230 may have, or define, a third web width value 238 measured across the third segment axis 234.

As shown in FIG. 2B, the holes 212, 222, 232 may be substantially centered on the first major surface 208, such that the respective web width values are substantially equally distributed (e.g., equally distributed or about equally distributed) on each side of the respective hole. For example, half of the first web width value 218 may be on the left side of the first hole 212 and the other half of the first web width value 218 may be on the right side of the first hole 212. While the holes are primarily illustrated herein as substantially centered on the first major surface, it will be understood in light of this disclosure that one or more of the holes may be non-centered on the first major surface. In just one such example, 60% of the first web width value 218 may be on the left side of the first hole 212 and the other 40% of the first web width value 218 may be on the right side of the first hole 212.

In at least one embodiment, the web width value of each segment may decrease as the plurality of segments 209 extends along the longitudinal axis 206 from the first end region 202 to the second end region 204. For example, the respective web width value of each segment may decrease as the plurality of segments 209 extends along the longitudinal axis 206 from the surface of the electrode into the electrode composite. As shown in FIG. 2B, the third web width value 238 may be less than the second web width value 228, which may be less than the first web width value 218, and so forth. Likewise, the first web width value 218 may be greater than the second web width value 228, which may be greater than the third web width value 238. In other words, the current collector 200 has tapering web width values decreasing from the first segment 210 to the third segment 230.

As described herein, the web width values decreasing from the first end region 202 to the second end region 204 may be desirable, for example, to provide increased mechanical durability where the current collector 200 may be subjected to greater stress (e.g., at the first end region 202) while also providing increased cohesion (e.g., cohesion of the electrode composite around and through the current collector 200) and decreased inactive volume elsewhere (e.g., at the second end region 204). More particularly, increased cohesion may be afforded by more electrode composite disposed in and through the larger third hole 232 and decreased inactive volume may be afforded by the reduced third web width value 238.

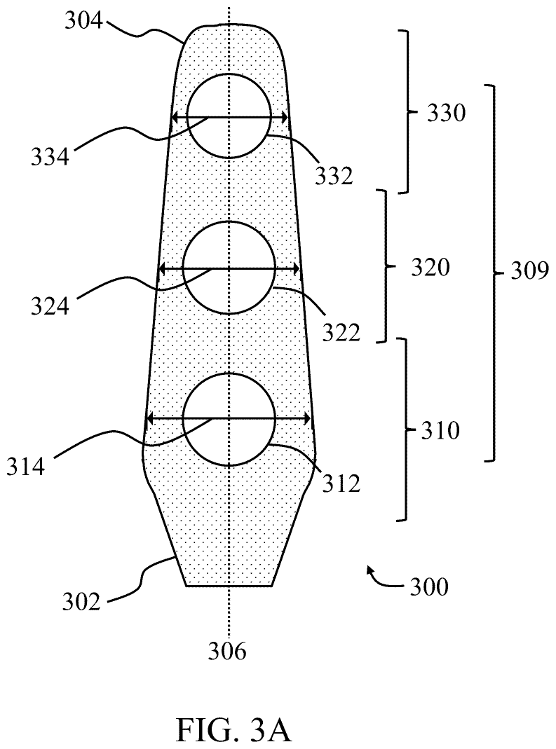

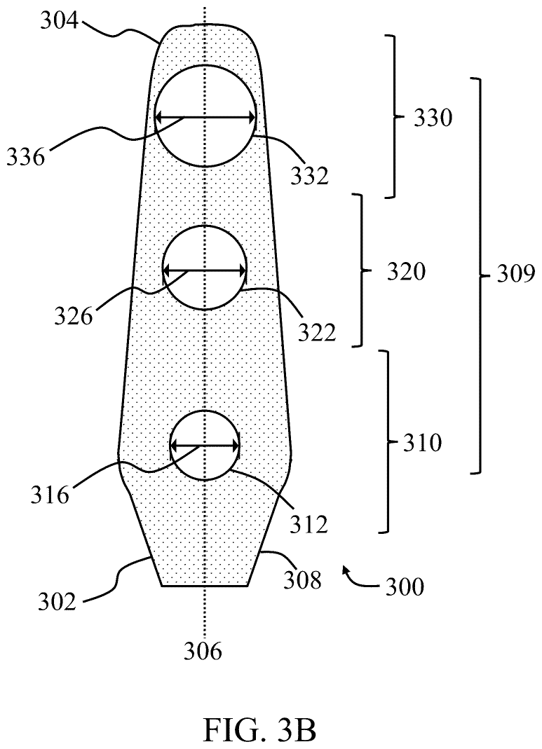

While the current collector 200 is shown in FIGS. 2A-2B as providing web width values decreasing from the first end region 202 to the second end region 204 via increasing hole width values from the first end region 202 to the second end region 204, decreasing web width values may additionally or alternatively be afforded via decreasing segment width values, or by a tapered current collector width value. For example, cross-sectional side views of another illustrative current collector 300 are shown in FIGS. 3A-3B. All design considerations and possibilities described herein regarding current collector 200 of FIGS. 2A-2B apply equally to current collector 300 of FIGS. 3A-3B. The illustrative current collector 300 may have a plurality of segments 309 (e.g., a first segment 310, a second segment 320, and a third segment 330). Each segment of the plurality of segments 309 may have, or define, a segment width value, which may by measured across the respective segment, such as across a maximum width of the respective hole. For example, the first segment 310 may have a first segment width value 314 measured across a maximum width of the first hole 312, the second segment 320 may have a second segment width value 324 measured across a maximum width of the second hole 322, and the third segment 330 may have a third segment width value 334 measured across a maximum width of the third hole 332. The respective width of each segment may decrease from a first end region 302 to a second end region 304 along the longitudinal axis 306. For example, the first segment width value 314 may be greater than the second segment width value 324, which may be greater than the third segment width value 334. Likewise, the third segment width value 334 may be less than the second segment width value 324, which may be less than the first segment width value 314. In other words, the respective segment width value of each segment may decrease as the plurality of segments 309 extends along the longitudinal axis 306 from the first end region 302 to the second end region 304 (e.g., from the surface of the electrode into the electrode composite).

In some embodiments, each hole of the plurality of segments 309 may have substantially equal (e.g., equal or nearly equal), hole width values. In other words, the respective hole width value of each segment may be substantially equal. For example, as shown in FIG. 3A, the first hole 312, the second hole 322, and the third hole 332 may have substantially equal hole width values (hole width values not expressly shown in FIG. 3A). Additionally or alternatively, as shown in FIG. 3B, the plurality of segments 309 may have hole width values increasing from the first end region 302 to the second end region 304. For example, the first hole width value 316 may be less than the second hole width value 326, which may be less than the third hole width value 336. Likewise, the third hole width value 336 may be greater than the second hole width value 326, which may be greater than the first hole width value 316.

Cross-sectional side views of various embodiments of an illustrative current collector 400 are shown in FIGS. 4A-4G. All design considerations and possibilities described herein regarding current collector 200 of FIGS. 2A-2B and current collector 300 of FIGS. 3A-3B apply equally to current collector 400 of FIGS. 4A-4G. In one or more embodiments, and as best shown in FIG. 4A and FIG. 4B, the current collector 400 may include, or define, one or more notches 480, or scallops, between a segment of the plurality of segments and at least one adjacent segment. Notches may be desirable, for example, to reduce the inactive volume in an electrode assembly, and/or for improved cohesion (e.g., cohesion of the electrode composite around and through the current collector 400). In some embodiments, the plurality of holes of the current collector 400 may be, or include, shapes such as rounded squares (FIG. 4C), hexagons (FIG. 4D), lobed shapes (e.g., 5-lobed stars, as in FIG. 4E), or triangles (FIG. 4F), as just a few examples. Additionally or alternatively, the plurality of holes may be, or include, any number of holes, such as 2 holes (FIG. 4C), 3 holes (see, e.g., FIG. 4A), 4 holes (FIG. 4E), 5 holes (FIG. 4F), etc. It will be understood in light of this disclosure that any suitable number of holes may be used and the disclosure is not limited in this regard.

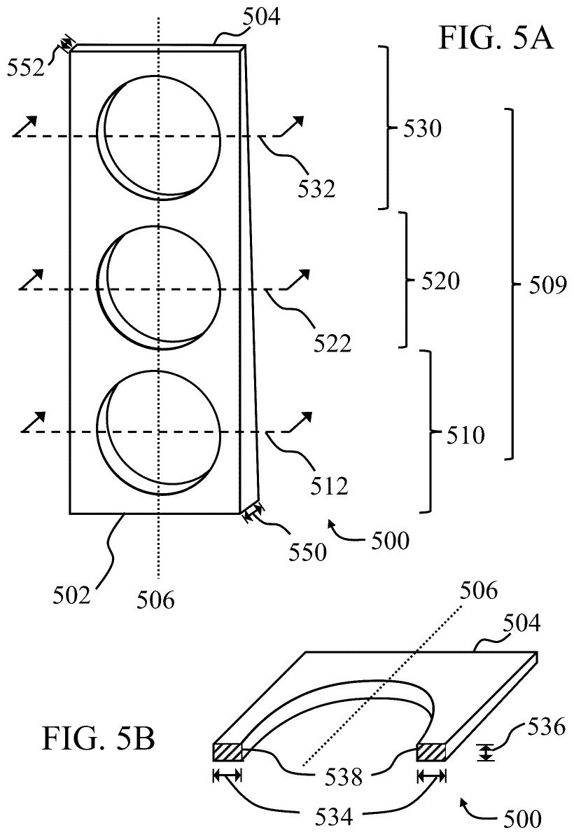

While the overall or taper of amount of material in the current collector is primarily illustrated herein regarding respective web widths of each segment, the current collectors described herein may additionally or alternatively include overall tapers with regard to other measures, such as thickness and/or cross-sectional area of the respective web of each segment. For example, a perspective view of an illustrative current collector 500 with a tapered thickness is shown in FIGS. 5A-5B. It will be understood in light of the present disclosure that all design considerations and possibilities described herein regarding current collector 200 of FIGS. 2A-2B, current collector 300 of FIGS. 3A-3B, and current collector 400 of FIGS. 4A-4G apply equally to current collector 500 of FIGS. 5A-5B. The thickness of the current collector 500 may decrease along a longitudinal axis 506 from a first end region 502 to a second end region 504. The thickness of the current collector 500 may be described as a dimension of the current collector 500 measured along an axis extending through the current collector 500 from the first major surface to the second major surface and optionally substantially perpendicular (e.g., perpendicular or nearly perpendicular), to the first major surface and/or the second major surface. In other words, the current collector may have, or define, a first current collector thickness value 550 (measured, e.g., at the first end region 502) and a second current collector thickness value 552 (measured, e.g., at the second end region 504) that is less than the first current collector thickness value 550.

In one or more embodiments, the web of each segment of a plurality of segments 509 may have, or define, a web thickness value, which may be described as a dimension of the web measured along an axis extending through the current collector 500 from the first major surface to the second major surface, optionally intersecting the respective segment axis, and optionally substantially perpendicular (e.g., perpendicular or nearly perpendicular) to the respective segment axis. In some embodiments, the respective web thickness is measured along an axis substantially perpendicular to the longitudinal axis 506. The respective web thickness value of each segment may decrease as the plurality of segments 509 extends along the longitudinal axis from the first end region 502 to the second end region 504 (e.g., from the surface of the electrode into the electrode).

In some embodiments, and as illustrated in FIG. 5A, the current collector 500 may have, or define, a taper with regard to a cross-sectional area value of the respective web of each segment of the plurality of segments 509. Each segment may have, or define, a web cross-sectional area value measured on a cross-sectional plane extending across the respective web and perpendicular to the longitudinal axis 506. In an example, the cross-sectional plane of each segment of the plurality of segments 509 may extend across a local minimum cross-sectional area of the respective web.

In one or more embodiments, a first segment 510 may have a first web cross-sectional area value (not expressly shown) measured on a first cross-sectional plane 512, a second segment 520 may have a second web cross-sectional area value (not expressly shown) measured on a second cross-sectional plane 522, and a third segment 530 may have a third web cross-sectional area value 538 measured on a third cross-sectional plane 532. In some embodiments, the web thickness value of each segment may be measured along an axis extending through the current collector 500 from the first major surface to the second major surface and optionally lying on the respective cross-sectional plane (e.g., the first cross-sectional plane 512, the second cross-sectional plane 522, or the third cross-sectional plane 532).

A cross-sectional perspective view across the third cross-sectional plane 532 of the illustrative current collector 500 of FIG. 5A is shown in FIG. 5B. Each web cross-sectional area value may be measured, for example, as a product of the respective web width value and the respective web thickness value. For example, the third web cross-sectional area value 538 may be measured as a product of the third web width value 534 and the third web thickness value 536. The respective web cross-sectional area of each segment may decrease as the plurality of segments 509 extends along the longitudinal axis 506 from the first end region 502 to the second end region 504. Furthermore, while the third web cross-sectional area value 538 is illustrated as rectangular in FIG. 5B, it will be understood in light of this disclosure that any suitable cross-sectional shape, or geometry, may be used. It will be further understood in light of the present disclosure that the cross-sectional area of suitable cross-sectional shapes, or geometries, may be determined or approximated using known techniques.

As described herein, the current collectors (e.g., the current collector 200, the current collector 300, the current collector 400 or the current collector 500) are, or include, an electrically conductive material. Any suitable electrically conductive current collector materials or combination of materials may be used. Suitable current collector materials may be selected based on mechanical durability, electrical conductivity, or material compatibility with the electrodes, as a few examples. Suitable current collector materials may include, for example, copper, aluminum, titanium, or stainless steel. Other examples of suitable current collector materials may include alloys, such as aluminum alloys or titanium alloys. It will be understood in light of the present disclosure that any suitable current collector materials may be used and the disclosure is not limited in this regard. It will be further understood in light of the present disclosure that suitable current collector materials may vary depending on factors, including those described herein.

While the respective hole of each segment is primarily illustrated herein as substantially circular (e.g., circular or nearly circular), any suitable hole shape or geometry may be used. Suitable hole shapes may be selected based on factors such as mechanical stability, cathode shape (e.g., tapered, prismatic, etc.), cathode aspect ratio, material properties of the cathode composite, device requirements, local material stresses, cross-section of electrically conductive material, volume of the current collector, cohesion of the electrode composite around and through the current collector, or current-carrying ability, as a few examples. Examples of suitable hole shapes or geometries may include, for example, ovals, lobed shapes (e.g., figure-8, stars, etc.), and/or polygons (e.g., polygons with rounded corners), such as triangles, squares, rectangles, trapezoids, and hexagons. It will be understood in light of the present disclosure that any suitable hole shape, or geometry, or combination of hole shapes, or geometries, may be used and the disclosure is not limited in this regard.

In some embodiments, as described herein, electrochemical cells (e.g., the electrochemical cell 100) may include one or more cathodes, which may be, for example, the first electrode (e.g., the first electrode 130) or the second electrode (e.g., the second electrode 140). The one or more cathodes may each be made of any suitable material or combination of materials. Suitable cathode materials may be selected based on capacity, interfacial kinetics, electrical conductivity, particle size, particle surface area, density, porosity, or tortuosity, as examples. Suitable cathode materials may include lithium cobalt oxide, as an example. For further examples, suitable cathode materials may include lithium-metal oxides (such as LiMn₂O₄, Li(NixMnyCoz)O₂, for example), vanadium oxides, olivines (such as LiFePO₄), rechargeable lithium oxides, silver vanadium oxide, carbon monofluoride, manganese dioxide, or graphite. It will be understood in light of the present disclosure that any suitable cathode materials may be used and the disclosure is not limited in this regard. It will be further understood in light of the present disclosure that suitable cathode materials may vary depending on factors, including those described herein.

In some embodiments, as described herein, the electrochemical cell (e.g., the electrochemical cell 100) may include one or more anodes, which may be, for example, the first electrode (e.g., the first electrode 130) or the second electrode (e.g., the second electrode 140). The one or more anodes may be made of any suitable material or combination of materials. Suitable anode materials may be selected based on capacity, interfacial kinetics, electrical conductivity, particle size, particle surface area, density, porosity, and tortuosity, as examples. Suitable anode materials may include, for example, graphite or copper. For further examples, suitable anode materials may include graphite, lithium titanium oxide, lithium, lithium-alloying materials, intermetallic materials (e.g., alloys), or silicon. In some embodiments, the anode may include a copper foil, which may include a layer of metallic lithium, such as a coating or plating of lithium or of a lithium alloy. It will be understood in light of the present disclosure that any suitable anode materials may be used and the disclosure is not limited in this regard. It will be further understood in light of the present disclosure that suitable anode materials may vary depending on factors, including those described herein.

As described herein, each segment of the plurality of segments (e.g., the plurality of segments 209, the plurality of segments 309, etc.) may have, or define, a respective web width value (e.g., the first web width value 218, the second web width value 228, the third web width value 238, etc.). Each segment may have any suitable web width value. Suitable web width values may be selected based on factors such as relative hole width value, relative segment width value, expected stresses on the respective segment, mechanical durability, web thickness, resistivity, manufacturing method (e.g., stamping, or chemical etching, etc.), as examples. Suitable web width values may include, for example, between 0.2 millimeters (mm) and 2 mm or between 0.2 mm and 1 mm. In one example, at least one web width value may be approximately 0.5 mm. Further examples of suitable web width values may include 0.2 mm or greater, 0.5 mm or greater, 0.8 mm or greater, 1 mm or greater, 1.4 mm or greater, 1.6 mm or greater, or 2 mm or greater and/or 2 mm or less, 1.8 mm or less, 1.2 mm or less, 1 mm or less, 0.8 mm or less, 0.5 mm or less, or 0.4 mm or less. In still another example, suitable web width values may be twice the respective web thickness value or greater. It will be understood in light of this disclosure that any suitable web width values may be used and the disclosure is not limited in this regard. It will further be understood that suitable web width values may depend on factors, such as those described herein.

As described herein, each segment of the plurality of segments (e.g., the plurality of segments 209, the plurality of segments 309, etc.) may have, or define, a respective hole width value (e.g., the first hole width value 216, the second hole width value 226, the third hole width value 236, etc.). Each segment may have any suitable hole width value. Suitable hole width values may be selected based on factors such as relative web width value, relative segment width value, desired interfacial area between the current collector and the electrode, desired cohesion, expected stresses on the respective segment, mechanical durability, respective web thickness value, aspect ratio of the web (e.g., ratio of the web thickness value to a web length value, which may be defined as a dimension of the web measured substantially parallel to the longitudinal axis), resistivity of the web, or manufacturing method (e.g., stamping, or chemical etching, etc.), as examples. Suitable hole width values may include, for example, between 0.5 mm and 5 mm or between 2 mm and 5 mm. In an example, the hole width values may be, or include, approximately 3 mm. Further examples of suitable hole width values may include 0.5 mm or greater, 0.7 mm or greater, 1 mm or greater, 2 mm or greater, 2.5 mm or greater, 3 mm or greater, 4 mm or greater, or 5 mm or greater, and/or 6 mm or less, 5 mm or less, 4 mm or less, 3 mm or less, 2 mm or less, 1 mm or less, or 0.5 mm or less. In still another example, suitable hole width values may be half a respective electrode width value or greater. It will be understood in light of this disclosure that any suitable hole width values may be used and the disclosure is not limited in this regard. It will further be understood that suitable hole width values may depend on factors, such as those described herein.

As described herein, each segment of the plurality of segments (e.g., the plurality of segments 209, the plurality of segments 309, etc.) may have, or define, a respective segment width value (e.g., the first segment width value 314, the second segment width value 324, the third segment width value 334, etc.). Each segment may have any suitable segment width value. Suitable segment width values may be selected based on factors such as relative web width value, relative hole width value, desired interfacial area between the current collector and the electrode, desired cohesion, expected stresses on the respective segment, mechanical durability, width of the respective electrode, manufacturing method (e.g., stamping, or chemical etching, etc.), resistivity, or relative web thickness value, as examples. Suitable segment width values may include, for example, between 0.6 mm and 6 mm or between 2 mm and 6 mm. In one example, at least one segment width value may be approximately 3.25 mm. Further examples of suitable segment width values may include 0.5 mm or greater, 0.6 mm or greater, 0.8 mm or greater, 1 mm or greater, 2 mm or greater, 3 mm or greater, 4 mm or greater, 5 mm or greater, or 6 mm or greater, and/or 7 mm or less, 6 mm or less, 5 mm or less, 4 mm or less, 3 mm or less, 2 mm or less, 1 mm or less, 0.8 mm or less, or 0.6 mm or less. It will be understood in light of this disclosure that any suitable segment width values may be used and the disclosure is not limited in this regard. It will further be understood that suitable segment width values may depend on factors, such as those described herein.

As described herein, each segment of the plurality of segments (e.g., the plurality of segments 209, the plurality of segments 309, etc.) may have, or define, a respective web thickness value (e.g., the third web thickness value 336). Each segment may have any suitable web thickness value. Suitable web thickness values may be selected based on factors such as relative web width value, desired interfacial area between the current collector and the electrode, desired cohesion, expected stresses on the respective segment, mechanical durability, manufacturing of an interconnect (e.g., an interconnect weld with a feedthrough pin), resistivity, thickness of the respective electrode, length of the respective web, or manufacturing method (e.g., stamping, or chemical etching, etc.), as examples. Suitable web thickness values may include, for example, between 0.025 mm and 0.25 mm or between 0.025 mm and 0.05 mm. In one example, at least one web thickness value may be approximately 0.05 mm. Further examples of suitable web thickness values may include 0.025 mm or greater, 0.04 mm or greater, 0.05 mm or greater, 0.07 mm or greater, 0.09 mm or greater, 0.1 mm or greater, 0.2 mm or greater, or 0.25 mm or greater, and/or 0.3 mm or less, 0.25 mm or less, 0.2 mm or less, 0.1 mm or less, 0.08 mm or less, 0.06 mm or less, 0.05 mm or less, 0.04 mm or less, or 0.03 mm or less. It will be understood in light of this disclosure that any suitable web thickness values may be used and the disclosure is not limited in this regard. It will further be understood that suitable web thickness values may depend on factors, such as those described herein.

As described herein, each segment of the plurality of segments (e.g., the plurality of segments 209, the plurality of segments 309, etc.) may have, or define, a respective web cross-sectional area value (e.g., the third web cross-sectional area value 338). Each segment may have any suitable web cross-sectional area value. Suitable web cross-sectional area values may be selected based on factors such as relative web width value, relative web thickness value, expected stresses on the respective segment, mechanical durability, resistivity, length of the respective web, cross-sectional area of the respective electrode, or manufacturing method (e.g., stamping, or chemical etching, etc.), as examples. Suitable web cross-sectional area values may include, for example, between 0.02 square millimeters (mm²) and 0.2 mm² or between 0.03 mm² and 0.06 mm². In one example, at least one web cross-sectional area may be approximately 0.4 mm². Further examples of suitable web cross-sectional area values may include 0.02 mm² or greater, 0.03 mm² or greater, 0.04 mm² or greater, 0.06 mm² or greater, 0.08 mm² or greater, 0.1 mm² or greater, 0.12 mm² or greater, 0.16 mm² or greater, or 0.2 mm² or greater, and/or 0.2 mm² or less, 0.16 mm² or less, 0.12 mm² or less, 0.1 mm² or less, 0.08 mm² or less, 0.06 mm² or less, 0.04 mm² or less, 0.03 mm² or less, or 0.02 mm² or less. It will be understood in light of this disclosure that any suitable web cross-sectional area values may be used and the disclosure is not limited in this regard. It will further be understood that suitable web cross-sectional area values may depend on factors, such as those described herein.

In one or more embodiments, and as described herein, the electrochemical cell (e.g., the electrochemical cell 100) may include an electrolyte. Although not expressly labeled in the figures, the electrolyte may generally fill at least a portion of any spaces inside the housing not filled by the other components of the electrochemical cell. The electrochemical cell may include a volume not filled by electrolyte (that is, a void). The void may be desirable, for example, to avoid overpressure of the housing, or enclosure. The electrolyte may facilitate ion transfer between the electrodes. The electrolyte may have an electrical potential. The electrolyte may include any suitable material and may be one or more of, for example, a liquid, a gel, a solid, or a paste. The material composition of the electrolyte may depend on a cell type of the electrochemical cell. The material composition of the electrolyte may include, for example, lithium salt, or other suitable electrolyte. The electrolyte may include a non-aqueous solution in which a lithium salt (for example, lithium hexafluorophosphate salt) is dissolved in an organic carbonate solvent (such as, for example, mixtures including one or more of ethylene carbonate, dimethyl carbonate, propylene carbonate, diethyl carbonate, or ethyl methyl carbonate). It will be understood in light of the present disclosure that any electrolyte composition may be used and the disclosure is not limited in this regard.

In various embodiments, the electrochemical cell may include various insulators (not shown in the figures) to insulate the conductive components (such as the housing, the one or more current collectors, and the electrode, for a few examples) from one another. The insulators may be made of any suitable material or combination of materials. Suitable insulator materials may include, for example, polytetrafluorocthylene (PTFE), polysulfone, glass, and ceramic materials (such as alumina). It will be understood in light of the present disclosure that any suitable insulator materials may be used and the disclosure is not limited in this regard.

In one or more embodiments, the electrochemical cell may include various electrical connections, such as between conductive components. Such electrical connections may be made by intimate contact between two or more conducting materials. Additionally or alternatively, such electrical connections may be made by welding two or more conducting materials together (e.g., by resistance welding or laser welding). Where conducting materials have at least slightly incompatible metallurgical characteristics (such as in a connection between titanium and copper), a weld interposer (e.g., a vanadium weld interposer) may be used to manage weld stability and strength.

### ILLUSTRATIVE ASPECTS

The following is a list of illustrative aspects according to the present disclosure.

Aspect 1 is an electrochemical cell comprising:
a first electrode comprising an electrode composite;
an elongate current collector defining a longitudinal axis and extending from a surface of the first electrode and into the first electrode along the longitudinal axis, the current collector comprising electrically conductive material and having:
   a first major surface and an opposing second major surface; and
   a plurality of current collector segments extending along the longitudinal axis, each segment having:
      a web of the electrically conductive material, the web (i) defining a hole extending through the current collector from the first major surface to the second major surface and having a respective hole width value measured along a respective segment axis extending across the hole and perpendicular to the longitudinal axis; (ii) having a respective web width value measured along the respective segment axis; and (iii) connecting the segment to at least one adjacent current collector segment, wherein each segment defines a respective segment width value measured along the respective segment axis;
   wherein the respective web width values decrease as the plurality of segments extends along the longitudinal axis from the surface of the electrode into the electrode;
a second electrode;
a separator disposed between the first electrode and the second electrode; and
an electrolyte.

Aspect 2 is the electrochemical cell of aspect 1, wherein the electrode composite is disposed within each hole of the plurality of segments.

Aspect 3 is the electrochemical cell of any one of aspects 1-2, wherein at least one segment of the plurality of segments is at least partially discrete from the respective at least one adjacent current collector segment.

Aspect 4 is the electrochemical cell of any one of aspects 1-3, wherein at least one segment of the plurality of segments is continuous with the respective at least one adjacent current collector segment.

Aspect 5 is the electrochemical cell of any one of aspects 1-4, wherein the current collector is monolithic.

Aspect 6 is the electrochemical cell of any one of aspects 1-5, wherein the respective segment axis of each segment is defined across a maximum hole width of the respective hole.

Aspect 7 is the electrochemical cell of any one of aspects 1-6, wherein the respective segment axis of each segment is defined across a minimum web width of the respective web.

Aspect 8 is the electrochemical cell of any one of aspects 1-7, wherein the respective hole width value of each segment increases as the plurality of segments extends along the longitudinal axis from the surface of the electrode into the electrode, wherein the respective segment width value of each segment decreases as the plurality of segments extends along the longitudinal axis from the surface of the electrode into the electrode, or both.

Aspect 9 is the electrochemical cell of any one of aspects 1-8, wherein the respective hole width value of each segment is equal, or wherein the respective segment width value of each segment is equal.

Aspect 10 is the electrochemical cell of any one of aspects 1-9, wherein the current collector further defines a notch between a segment of the plurality of segments and the respective at least one adjacent segment.

Aspect 11 is a current collector comprising:
an elongate body defining a longitudinal axis and extending from a first end region to a second end region along the longitudinal axis, the elongate body comprising electrically conductive material and having:
   a first major surface and an opposing second major surface; and
   a plurality of current collector segments extending along the longitudinal axis, each segment having:
      a web of the electrically conductive material, the web (i) defining a hole extending through the elongate body from the first major surface to the second major surface and having a respective hole width value measured along a respective segment axis extending across the hole and perpendicular to the longitudinal axis; (ii) having a respective web width value measured along the respective segment axis; and (iii) connecting the current collector segment to at least one adjacent current collector segment, wherein each segment defines a respective segment width value measured along the respective segment axis;
   wherein the respective web width value of each segment decreasing as the plurality of segments extends along the longitudinal axis from the first end region of the elongate body to the second end of the elongate body.

Aspect 12 is the current collector of aspect 11, wherein at least one segment of the plurality of segments is at least partially discrete from the respective at least one adjacent current collector segment.

Aspect 13 is the current collector of any one of aspects 11-12, wherein at least one segment of the plurality of segments is continuous with the respective at least one adjacent current collector segment.

Aspect 14 is the current collector of any one of aspects 11-13, wherein the elongate body is monolithic.

Aspect 15 is the current collector of any one of aspects 11-14, wherein the respective segment axis of each segment is defined across a maximum hole width of the respective hole.

Aspect 16 is the current collector of any one of aspects 11-15, wherein the respective segment axis of each segment is defined across a minimum web width of the respective web.

Aspect 17 is the current collector of any one of aspects 11-16, wherein the respective hole width value of each segment increases as the plurality of segments extends along the longitudinal axis from the first end region of the elongate body to the second end of the elongate body, wherein the respective segment width value of each segment decreases as the plurality of segments extends along the longitudinal axis from the first end region of the elongate body to the second end region of the elongate body, or both.

Aspect 18 is the current collector of any one of aspects 11-17, wherein the respective hole width value of each segment is equal, or wherein the respective segment width value of each segment is equal.

Aspect 19 is the current collector of any one of aspects 11-18, wherein the elongate body further defines a notch between a segment of the plurality of segments and the respective at least one adjacent segment.

Aspect 20 is a current collector comprising:
an elongate body defining a longitudinal axis and extending from a first end region to a second end region along the longitudinal axis, the elongate body comprising electrically conductive material and having:
   a first major surface and an opposing second major surface; and
   a plurality of current collector segments extending along the longitudinal axis, each segment having:
      a web of the electrically conductive material, the web (i) defining a hole extending through the elongate body from the first major surface to the second major surface; (ii) having a respective web cross-sectional area measured on a respective cross-sectional plane extending across a respective local minimum cross-sectional area of the web and perpendicular to the longitudinal axis; and (iii) connecting the segment to at least one adjacent current collector segment;
   wherein the respective web cross-sectional area of each segment decreasing as the plurality of segments extends along the longitudinal axis from the first end region of the elongate body to the second end region of the elongate body.

Aspect 21 is the current collector of aspect 20, wherein the web of each segment further has a respective web thickness value measured along a respective axis extending through the elongate body from the first major surface to the second major surface and optionally lying on the respective cross-sectional plane, and
wherein the respective web thickness values of each segment decrease as the plurality of segments extends along the longitudinal axis from the first end region of the elongate body to the second end region of the elongate body.

Aspect 22 is the current collector of any one of aspects 20-21, wherein each segment further has a respective segment width value measured along a respective axis parallel to the first major surface or the second major surface and optionally lying on the respective cross-sectional plane, and
wherein the respective segment width value of each segment decreases as the plurality of segments extends along the longitudinal axis from the first end region of the elongate body to the second end region of the elongate body.

It should also be noted that, as used in this specification and the appended claims, the phrase “configured” describes a system, apparatus, or other structure that is constructed to perform a particular task or adopt a particular configuration. The word “configured” can be used interchangeably with similar words such as “arranged,” “constructed,” “manufactured,” and the like.

All publications and patent applications in this specification are indicative of the level of ordinary skill in the art to which this technology pertains. All publications and patent applications are herein incorporated by reference to the same extent as if each individual publication or patent application was specifically and individually indicated by reference. In the event that any inconsistency exists between the disclosure of the present application and the disclosure(s) of any document incorporated herein by reference, the disclosure of the present application shall govern.

This application is intended to cover adaptations or variations of the present subject matter. It is to be understood that the above description is intended to be illustrative, and not restrictive, and the claims are not limited to the illustrative embodiments as set forth herein.

What is claimed is:

1. An electrochemical cell comprising:
a first electrode comprising an electrode composite;
an elongate current collector defining a longitudinal axis and extending from a surface of the first electrode and into the first electrode along the longitudinal axis, the current collector comprising electrically conductive material and having:
a first major surface and an opposing second major surface; and
a plurality of current collector segments extending along the longitudinal axis, each segment having:
a web of the electrically conductive material, the web (i) defining a hole extending through the current collector from the first major surface to the second major surface and having a respective hole width value measured along a respective segment axis extending across the hole and perpendicular to the longitudinal axis, (ii) having a respective web width value measured along the respective segment axis, and (iii) connecting the segment to at least one adjacent current collector segment, wherein each segment defines a respective segment width value measured along the respective segment axis,
wherein the respective web width values decrease as the plurality of segments extends along the longitudinal axis from the surface of the electrode into the electrode;
a second electrode;
a separator disposed between the first electrode and the second electrode; and
an electrolyte.

2. The electrochemical cell of claim 1, wherein the electrode composite is disposed within each hole of the plurality of segments.

3. The electrochemical cell of claim 1, wherein at least one segment of the plurality of segments is at least partially discrete from the respective at least one adjacent current collector segment.

4. The electrochemical cell of claim 1, wherein at least one segment of the plurality of segments is continuous with the respective at least one adjacent current collector segment.

5. The electrochemical cell of claim 1, wherein the respective segment axis of each segment is defined across a maximum hole width or a minimum web width of the respective web.

6. The electrochemical cell of claim 1, wherein at least one of:
the respective hole width value of each segment increases as the plurality of segments extends along the longitudinal axis from the surface of the electrode into the electrode, or
the respective segment width value of each segment decreases as the plurality of segments extends along the longitudinal axis from the surface of the electrode into the electrode.

7. The electrochemical cell of claim 1, wherein at least one of the respective hole width value of each segment or the respective segment width value of each segment is equal.

8. The electrochemical cell of claim 1, wherein the current collector further defines a notch between a segment of the plurality of segments and the respective at least one adjacent segment.

9. A current collector comprising:
an elongate body defining a longitudinal axis and extending from a first end region to a second end region along the longitudinal axis, the elongate body comprising electrically conductive material and having:
a first major surface and an opposing second major surface; and
a plurality of current collector segments extending along the longitudinal axis, each segment having:
a web of the electrically conductive material, the web (i) defining a hole extending through the elongate body from the first major surface to the second major surface and having a respective hole width value measured along a respective segment axis extending across the hole and perpendicular to the longitudinal axis, (ii) having a respective web width value measured along the respective segment axis, and (iii) connecting the current collector segment to at least one adjacent current collector segment, wherein each segment defines a respective segment width value measured along the respective segment axis,
wherein the respective web width values decrease as the plurality of segments extends along the longitudinal axis from the first end region of the elongate body to the second end region of the elongate body.

10. The current collector of claim 9, wherein at least one segment of the plurality of segments is at least partially discrete from the respective at least one adjacent current collector segment.

11. The current collector of claim 9, wherein at least one segment of the plurality of segments is continuous with the respective at least one adjacent current collector segment.

12. The current collector of claim 9, wherein the elongate body is monolithic.

13. The current collector of claim 9, wherein the respective segment axis of each segment is defined across a maximum hole width of the respective hole.

14. The current collector of claim 9, wherein the respective segment axis of each segment is defined across a minimum web width of the respective web.

15. The current collector of claim 9, wherein the respective hole width value of each segment increases as the plurality of segments extends along the longitudinal axis from the first end region of the elongate body to the second end region of the elongate body, wherein the respective segment width value of each segment decreases as the plurality of segments extends along the longitudinal axis from the first end region of the elongate body to the second end region of the elongate body, or both.

16. The current collector of claim 9, wherein the respective hole width value of each segment is equal, or wherein the respective segment width value of each segment is equal.

17. The current collector of claim 9, wherein the elongate body further defines a notch between a segment of the plurality of segments and the respective at least one adjacent segment.

18. A current collector comprising:
an elongate body defining a longitudinal axis and extending from a first end region to a second end region along the longitudinal axis, the elongate body comprising electrically conductive material and having:
a first major surface and an opposing second major surface; and
a plurality of current collector segments extending along the longitudinal axis, each segment having:
a web of the electrically conductive material, the web (i) defining a hole extending through the elongate body from the first major surface to the second major surface, (ii) having a respective web cross-sectional area value measured on a respective cross-sectional plane extending across a respective local minimum cross-sectional area of the web and perpendicular to the longitudinal axis, and (iii) connecting the segment to at least one adjacent current collector segment,
wherein the respective web cross-sectional area values decrease as the plurality of segments extends along the longitudinal axis from the first end region of the elongate body to the second end region of the elongate body.

19. The current collector of claim 18, wherein the web of each segment further has a respective web thickness value measured along a respective axis extending through the elongate body from the first major surface to the second major surface and optionally lying on the respective cross-sectional plane, and
wherein the respective web thickness values of each segment decrease as the plurality of segments extends along the longitudinal axis from the first end region of the elongate body to the second end region of the elongate body.

20. The current collector of claim 18, wherein each segment further has a respective segment width value measured along a respective axis parallel to the first major surface or the second major surface and optionally lying on the respective cross-sectional plane,
and wherein the respective segment width values of each segment decrease as the plurality of segments extends along the longitudinal axis from the first end region of the elongate body to the second end region of the elongate body.
